(19) United States
(12) Patent Application Publication
(10) Pub. No.: US 2010/0236681 A1
(43) Pub. Date: Sep. 23, 2010

(54) TIRE HAVING TREAD BLOCKS WITH BLENDED WALLS

(76) Inventor: Daniel Ray Beha, Akron, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/405,267

(22) Filed: Mar. 17, 2009

(51) Int. Cl. B60C 11/03; B60C 11/12

(52) U.S. Cl. 152/209.18

(57) ABSTRACT

A pneumatic tire includes a carcass having an axis of rotation and a tread disposed radially outward of the carcass. The tread includes a plurality of grooves and a plurality of tread blocks located between the grooves. Each of the tread blocks has a road-contacting surface and at least one wall extending from the road-contacting surface so as to border at least one of the grooves. The wall has a faceted radially outer edge blending radially inward to a linear base of the tread block. The base of the tread block transitions to a base surface of the corresponding groove to define an axially extending and concave transition surface therebetween.

### FIELD OF THE INVENTION

The present invention generally relates to tire treads and, more particularly, to a pneumatic tire tread having tread blocks with blended walls and rounded wall/base transitions.

### BACKGROUND OF THE INVENTION

A conventional tire may include a tread with a tread pattern that, when the tire is loaded, defines a footprint providing a frictional engagement with a road or other contact surface. The tread pattern may be segmented into a plurality of raised blocks defined and separated by intersecting circumferential and transverse grooves. The grooves may provide flexibility and water removal while the blocks may determine control, acceleration, and/or braking characteristics of the tire. The circumferential grooves may be positioned such that the raised blocks are arranged in columns that extend circumferentially about a circumference of the tire.

Block dimensions, number of ribs, and inclination angle of the transverse grooves may determine overall performance of the tire. In particular, these factors may determine an amount of tread that contacts the road/contact surface, and hence, the traction and control of the vehicle riding on the tire. A nonskid, or groove, depth may determine an ability of the intersecting circumferential and transverse grooves to channel water out of the tread.

In a new condition, a tread pattern may be designed with compromises between these and other various design parameters in order to optimize performance of the tire. As a tire wears, the parameter choices that optimized performance of the tire's tread pattern in an unworn state may not continue to be optimal. For example, a new tire construction may be designed with a tread pattern having raised blocks in which noise reduction, due to high nonskid depth, is a controlling factor. However, blocks that provide a balanced tire behavior in a new condition may not exhibit optimized noise reduction and hydroplaning control in a worn condition, as a groove depth diminishes.

As a tread wears, noise created by contact between the road-contacting surfaces of the tread blocks and the road may diminish. However, a worn tire with conventional blocks may be significantly more susceptible to hydroplaning than a new tire.

For these and other reasons, it would be desirable to provide a tire tread that addresses these and other deficiencies of conventional tires by mitigating wear factors, such as stresses and cracking occurring at the outer walls of the tread blocks.

### SUMMARY OF THE INVENTION

In one example embodiment of the present invention, a pneumatic tire includes a carcass having an axis of rotation and a tread disposed radially outward of the carcass. The tread includes a plurality of grooves and a plurality of tread blocks located between the grooves. Each of the tread blocks has a road-contacting surface and at least one wall extending from the road-contacting surface so as to border at least one of the grooves. The wall has a faceted radially outer edge blending radially inward to a linear base of the tread block. The base of the tread block transitions to a base surface of the corresponding groove to define an axially extending and concave transition surface therebetween.

In one aspect of the present invention, the pneumatic tire includes a sidewall extending radially inward from two lateral edges of the tread.

In another aspect of the present invention, the pneumatic tire includes a shoulder defining a juncture between each sidewall and the tread.

In still another aspect of the invention, the carcass includes two bead portions, each having an annular inextensible bead and an apex.

In yet another aspect of the present invention, the carcass includes two sidewalls each terminating at a corresponding bead portion.

In still another aspect of the present invention, the carcass includes at least one composite ply structure having opposite turn-up ply ends, each wrapped about a bead portion.

In yet another aspect of the present invention, the pneumatic tire includes a belt package characterized by a plurality of individually cut belt plies.

In still another aspect of the present invention, the plies of the belt package consist of a cord reinforced elastomeric material.

In yet another aspect of the present invention, the pneumatic tire includes an innerliner for providing an air impervious chamber to maintain air pressure when the pneumatic tire is inflated.

In still another aspect of the present invention, the tread includes a plurality of continuous circumferential grooves and a plurality of transverse grooves that intersect with the circumferential grooves to define a lattice arrangement of grooves for the tread.

In yet another aspect of the present invention, the circumferential grooves are substantially parallel to one another so that the tread blocks are arranged in four circumferential ribs extending circumferentially about the pneumatic tire.

In still another aspect of the present invention, the transverse grooves extend between adjacent circumferential grooves.

In yet another aspect of the present invention, the transverse grooves extend between a circumferential groove and a lateral edge of the tread.

In still another aspect of the present invention, the transverse grooves extend across an axial width of the pneumatic tire relative to an equatorial plane of the pneumatic tire.

### BRIEF DESCRIPTION OF THE DRAWINGS

The accompanying drawings, which are incorporated in and constitute a part of this specification, illustrate an example embodiment of the present invention and, together with a general description of the present invention given above and the example detailed description given below, serve to explain, but not limit, the present invention.

FIG. 1 is a schematic cross-sectional view of an example tire for use with the present invention;

FIG. 2 is an example perspective view of an example tire tread in accordance with the present invention;

FIG. 3 is a schematic front elevation view of the example tire of FIG. 2;

FIG. 4 is a schematic detailed front elevation view of the example tire of FIG. 2;

FIG. 5 is a schematic section view taken along line 5-5 in FIG. 4; and

FIG. 6 is a schematic perspective view of the example tire of FIG. 2.

### DEFINITIONS

“Apex” means an elastomeric filler located radially above the bead core and between the plies and the turnup ply.

“Axial” and “axially” mean the lines or directions that are parallel to the axis of rotation of the tire.

“Bead” means that part of the tire comprising an annular tensile member wrapped by ply cords and shaped to fit the design rim, with or without other reinforcement elements such as flippers, chippers, apexes, toe guards and chafers.

“Carcass” means the tire structure apart from the belt structure, tread, undertread, and sidewall rubber over the plies, but including the beads.

“Circumferential” means circular lines or directions extending along the surface of the sidewall perpendicular to the axial direction.

“Cord” means one of the reinforcement strands of which the plies in the tire are comprised.

“Cut belt or cut breaker reinforcing structure” means at least two cut layers of plies of parallel cords, woven or unwoven, underlying the tread, unanchored to the bead, and having both left and right cord angles in the range from 10 degrees to 33 degrees with respect to the equatorial plane of the tire.

“Equatorial plane (EP)” means the plane perpendicular to the tire's axis of rotation and passing through the center of its tread.

“Footprint” means the contact patch or area of contact of the tire tread with a flat surface at zero speed and under design load and pressure.

“Groove” means an elongated void area in a tread that may extend circumferentially or laterally about the tread in a straight, curved, or zigzag manner.

“Hydroplaning” refers to a condition wherein a tire in motion loses traction during wet pavement conditions because the tire is not in contact with the surface. The tire is in contact only with a film of liquid on the surface.

“Lateral” means a direction parallel to the axial direction, as in across the width of the tread or crown region.

“Lateral edge” means the axially outermost edge of the tread as defined by a plane parallel to the equatorial plane and intersecting the outer ends of the axially outermost traction lugs at the radial height of the inner tread surface.

“Leading” refers to a portion or part of the tread that contacts the ground first, with respect to a series of such parts or portions, during rotation of the tire in the direction of travel.

“Nonskid” means depth of grooves in a tire tread.

“Normal inflation pressure” refers to the specific design inflation pressure and load assigned by the appropriate standards organization for the service condition for the tire.

“Normal load” refers to the specific design inflation pressure and load assigned by the appropriate standards organization for the service condition for the tire.

“Pneumatic tire” means a laminated mechanical device of generally toroidal shape, usually an open-torus having beads and a tread and made of rubber, chemicals, fabric and steel or other materials.

“Radial” and “radially” mean directions radially toward or away from the axis of rotation of the tire.

“Rib” means a circumferentially extending strip of rubber on the tread which is defined by at least one circumferential groove.

“Shoulder” means the upper portion of sidewall just below the tread edge.

“Sidewall” means that portion of a tire between the tread and the bead area.

“Tire design load” is the base or reference load assigned to a tire at a specific inflation pressure and service condition; other load-pressure relationships applicable to the tire are based upon that base or reference load.

“Tread” means a molded rubber component which, when bonded to a tire casing, includes that portion of the tire that comes into contact with the road when the tire is normally inflated and under normal load.

“Tread width” means the arc length of the road contacting tread surface in the axial direction, that is, in a plane parallel to the axis of rotation of the tire.

“Turn-up ply” refers to an end of a carcass ply that wraps around one bead only.

### Detailed Description of an Example Embodiment of the Present Invention

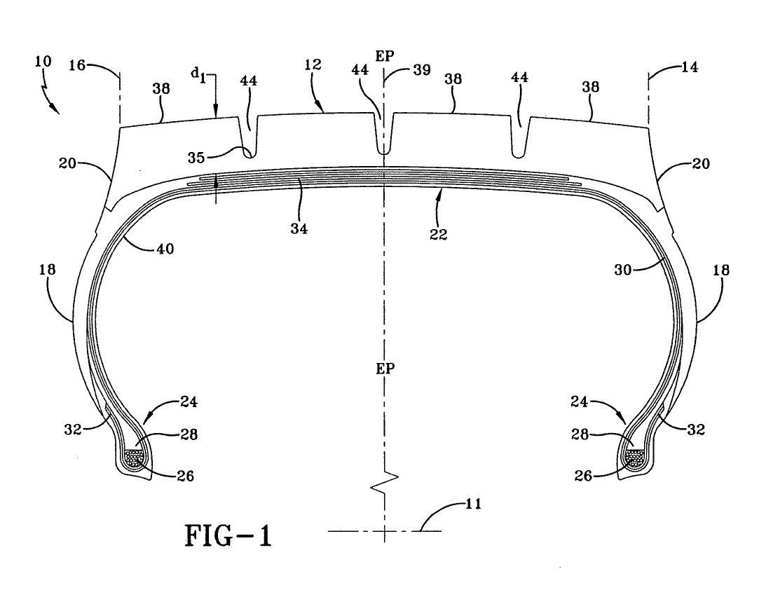

With reference to the FIG. 1, an example pneumatic tire 10 for use with the present invention may include a road-contacting tread 12 extending between lateral edges 14, 16, a sidewall 18 extending from each lateral edge 14, 16, respectively, a shoulder 20 defining a juncture between each sidewall 18 and the tread 12, and a carcass 22 defining a support structure for example tire 10. The tread 12 and sidewalls 18 may be comprised of a suitable material, such as a suitable natural or synthetic rubber compound. The example tire 10 may have a mid-circumferential or equatorial plane EP bisecting the tire midway between the lateral edges 14, 16. The example tire 10 may further include an axis of rotation 11 orthogonally intersecting the equatorial plane EP.

The carcass 22 may include a pair of bead portions 24, each having an annular inextensible bead 26 and an apex 28. Each of the sidewalls 18 may terminate at a corresponding one of the bead portions 24, which provide support for the example tire 10 and seal against a rim (not shown) to maintain air pressure in an interior of the example tire. The carcass 22 may further include at least one composite ply structure 30 having opposite turn-up ply ends 32, each wrapped about one of the bead portions 24. The example tire 10 may further include a belt package 34, typically characterized by a plurality of individually cut belt plies and/or spiral wound belt layers. The plies of the ply structure 30 and the belt package 34 may generally consist of cord reinforced elastomeric material in which cords are steel wire or polyamide filaments and an elastomer may be a vulcanized rubber material. The cord reinforced elastomeric material constituting the ply structure 30 and belt package 34 may be encased in, and bonded to, a suitable material, such as a suitable natural or synthetic rubber compound.

A plurality of the example tires 10 may be placed on a vehicle (not shown), such as an automobile. When each example tire 10 is mounted on a rim (not shown) and placed on the vehicle, the tread 12 may protect the carcass 22 and belt package 34 while providing traction for the vehicle against a road or contact surface. The example tire 10 may contain an inflation fluid, like nitrogen, air, other gas, and/or gas mixture, that may suitably support a vehicle and a vehicle load. An innerliner 40, which may be formed of a suitable material such as halobutyl rubber, may define an essentially air impervious chamber for maintaining the air pressure when the example tire 10 is inflated.

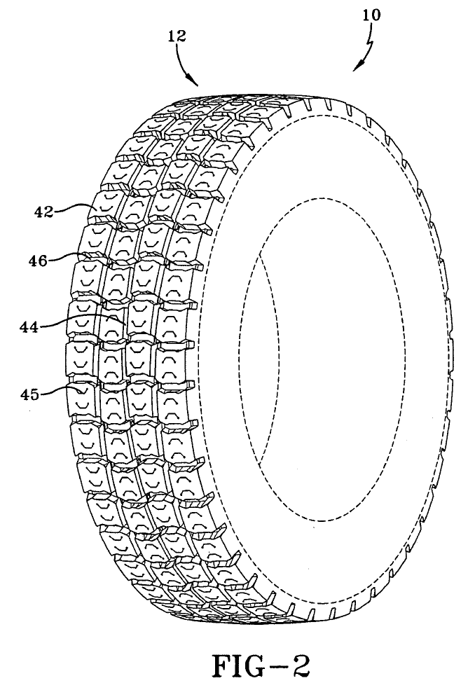

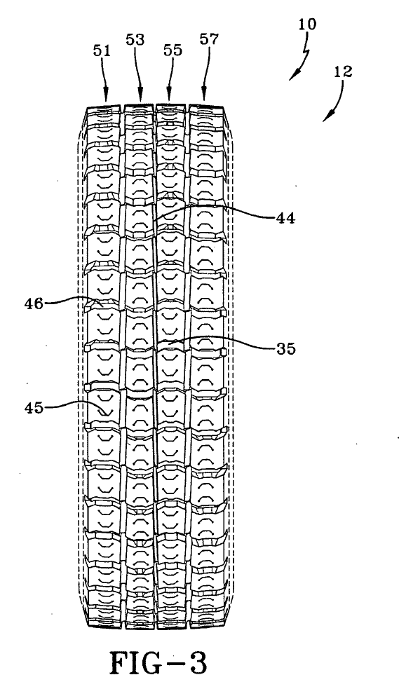

With reference to FIGS. 2-5, the example tread 12 is partitioned into a plurality of raised tread blocks 42 located between a plurality of continuous circumferential grooves 44 and a plurality of transverse or lateral grooves 46 that intersect with the circumferential grooves to define a lattice arrangement of grooves for the tread. The example circumferential grooves 44 are substantially parallel to one another so that the tread blocks 42 are arranged in four circumferential ribs, indicated generally at 51, 53, 55, 57 extending circumferentially about the example tire 10. Adjacent ribs 51, 53, 55, 57 may be separated from each other by one of the plurality of circumferential grooves 44.

Each of the example transverse grooves 46 may either extend between adjacent circumferential grooves 44 or between a circumferential groove 44 and one of the lateral edges 14, 16. The transverse grooves 46 may extend across an axial width of the example tire 10 relative to the equatorial plane EP. Each block 42 may be individually separated from an adjacent block 42 in the same rib 51, 53, 55, 57 by one of the transverse grooves 46.

The circumferential and transverse grooves 44, 46 may represent elongated void areas in the example tread 12. The blocks 42 may project radially outward from a base surface 35 of the tread 12. The transverse grooves 46 define radially and axially extending block walls 101 of the blocks 42. A nonskid depth d₁ may be represented by a distance measured from a road contacting surface 38 of each tread block 42 to the base surface 35. When driving on wet roads, the transverse grooves 44 may transfer a continuous flow of water transversely/laterally/axially out of the footprint of the example tread 12 for expulsion through the shoulders 20 of the tread. The presence of the transverse grooves 46 thus may alleviate a build up of water back pressure in a forward location of the rolling tire 10 and thereby facilitate maintaining rubber contact between the tread 12 and the road or contact surface.

Each example tread block 42 includes the radially outermost, contact surface 38 that contacts the road or other surface when periodically within a boundary of the tire footprint as the tire 10 rotates. Each of the tread blocks 42 may have a dimension in the circumferential direction of the tire 10 and a dimension in the transverse direction of tire 10 that may be the same or different from the circumferential dimension. The tread blocks 42 may be provided with sipes 45.

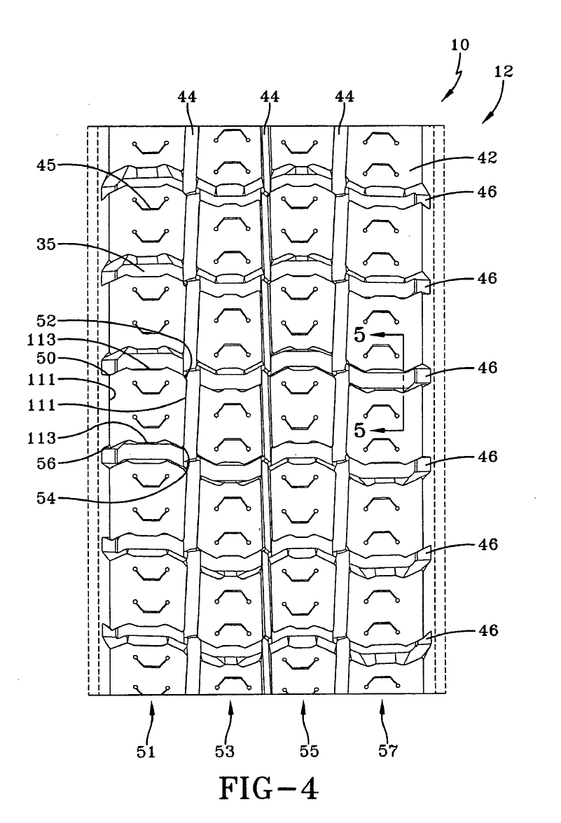

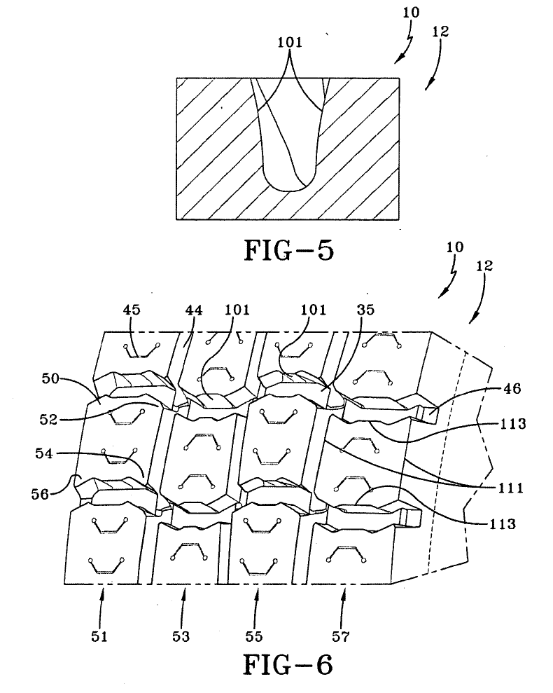

Each road-contacting surface 38 may be bounded by corners 50, 52, 54, 56 defining circumferential edges 111 and transverse edges 113. The circumferential edges 111 of the example tread blocks 42 are linear and extend in the circumferential direction of the tire 10. As shown in FIGS. 4 and 5, each of the transverse edges 113 defines the radially outermost edge of the transverse walls 101 of the tread blocks 42. Each pair of transverse edges 113 defines a plurality of linear edges producing faceted or zigzag radially outer transverse edges of the blocks 42.

Further, in accordance with the present invention, as the faceted transverse walls 101 extend radially inward from the faceted transverse edges 113, the transverse walls gradually transition or “blend” into a single planar surface terminating at the base of the tread blocks 42 and the transverse grooves 46 in axially extending, linear surfaces that are also rounded off, or concave, as the walls 101 transition from transverse radially extending walls to the base surface 35 of the transverse grooves 46 of the tread 12.

In use, the depth of grooves 44, 46 will decrease as the tread 12 wears. As the grooves 44, 46 become shallower, the corners 50, 52, 54, 56 approach the base surface 35. As a result, the road-contacting surface 38 is at a different resultant radial height above the base surface 35 and, hence, cuts through a different circumferential plane of the original tread block 42. As this occurs, the faceted shape of the edges 113 changes from zigzag to linear.

The faceting of the zigzag edges 113 at the tread surface 38, thus, blends radially inward to a single linear edge to define an axially extending and concave transition surface between the transverse wall 101 and the base surface 35. This allows the dissipation of stresses that form at the base of the transverse walls 101. By virtue of the foregoing, there is provided an improved pneumatic tire that addresses various deficiencies of conventional pneumatic tires.

While the invention has been illustrated by a description of various embodiments, and while these embodiments have been described in considerable detail, it is not the intention of the applicants to restrict or in any way limit the scope of the appended claims to such detail. Additional advantages and modifications will readily appear to those skilled in the art. Thus, the invention in its broader aspects is therefore not limited to the specific details, representative apparatus and method, and illustrative examples shown and described. Accordingly, departures may be made from such details without departing from the spirit or scope of applicants' general inventive concept.

What is claimed is:

1. A pneumatic tire comprising:
a carcass having an axis of rotation; and
a tread disposed radially outward of the carcass, the tread including a plurality of grooves and a plurality of tread blocks located between the grooves, each of the tread blocks having a road-contacting surface and at least one wall extending from the road-contacting surface so as to border at least one of the grooves,
the at least one wall having a faceted radially outer edge blending radially inward to a linear base of the tread block, the base of the tread block transitioning to a base surface of the corresponding groove to define an axially extending and concave transition surface therebetween.

2. The pneumatic tire as set forth in claim 1 further including a sidewall extending radially inward from two lateral edges of the tread.

3. The pneumatic tire as set forth in claim 2 further including a shoulder defining a juncture between each sidewall and the tread.

4. The pneumatic tire as set forth in claim 1 wherein the carcass includes two bead portions, each having an annular inextensible bead and an apex.

5. The pneumatic tire as set forth in claim 1 wherein the carcass includes two sidewalls each terminating at a corresponding bead portion.

6. The pneumatic tire as set forth in claim 1 wherein the carcass includes at least one composite ply structure having opposite turn-up ply ends, each wrapped about a bead portion.

7. The pneumatic tire as set forth in claim 1 further including a belt package characterized by a plurality of individually cut belt plies.

8. The pneumatic tire as set forth in claim 7 wherein the plies of the belt package consist of a cord reinforced elastomeric material.

9. The pneumatic tire as set forth in claim 1 further including an innerliner for providing an air impervious chamber to maintain air pressure when the pneumatic tire is inflated.

10. The pneumatic tire as set forth in claim 1 wherein the tread includes a plurality of continuous circumferential grooves and a plurality of transverse grooves that intersect with the circumferential grooves to define a lattice arrangement of grooves for the tread.

11. The pneumatic tire as set forth in claim 10 wherein the circumferential grooves are substantially parallel to one another so that the tread blocks are arranged in four circumferential ribs extending circumferentially about the pneumatic tire.

12. The pneumatic tire as set forth in claim 10 wherein the transverse grooves extend between adjacent circumferential grooves.

13. The pneumatic tire as set forth in claim 10 wherein the transverse grooves extend between a circumferential groove and a lateral edge of the tread.

14. The pneumatic tire as set forth in claim 10 wherein the transverse grooves extend across an axial width of the pneumatic tire relative to an equatorial plane of the pneumatic tire.
